(19) United States
(12) Patent Application Publication
(10) Pub. No.: US 2005/0128968 A1
(43) Pub. Date: Jun. 16, 2005

(54) System and method for selecting printer via wireless communication network and printing data

(75) Inventor: Woo-Seong Yang, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/006,782

(22) Filed: Dec. 8, 2004

(30) Foreign Application Priority Data
Dec. 13, 2003 (KR) 2003-90947

(51) Int. Cl. H04J 3/24

(52) U.S. Cl. 370/312; 370/338

(57) ABSTRACT

Provided are a printing system and method that selects a printer in a wireless communication network and prints data using the selected printer. The mobile communication terminal includes a wireless data receiving unit, which receives the information broadcasted by the printer; an access selecting unit, which determines a distance between the mobile communication terminal and each of the plurality of printers based on an intensity of a wireless signal transmitted from each of the plurality of printers; and a data transmitting and printing unit, which designates one of the plurality of printers that is located nearest to the mobile communication terminal as a printer to be used by referring to the distance between the mobile communication terminal and each of the plurality of printers and transmits data to be printed to the printer to be used via the wireless communication network.

### CROSS-REFERENCE TO RELATED APPLICATION

This application claims the benefit under 35 U.S.C. §119(a) of Korean Patent Application No. 2003-90947, filed on Dec. 13, 2003, in the Korean Intellectual Property Office, the entire disclosure of which is hereby incorporated by reference.

### BACKGROUND OF THE INVENTION

1. Field of the Invention

The present invention relates to wireless communications. More particularly, the present invention relates to a printing system and method that selects, via a wireless communication network, a printer that is located nearest to a mobile communication terminal, such as a mobile phone, a personal digital assistant (PDA), or a laptop computer, and prints data using the selected printer without additional printer setting.

2. Description of the Related Art

There are various conventional printing methods and systems that transmit data to be printed from a mobile communication terminal to a printer in a wireless manner and print the data to be printed with the use of the printer. FIG. 1 illustrates a conventional printing system that transmits data to be printed to a printer in a wireless manner. Referring to FIG. 1, the conventional printing system includes a printer 100, which prints documents, a local area network (LAN) 130, via which data is transmitted, and a mobile device 140, which transmits data to be printed to the printer 100 and a wireless communication network adaptor 110, which enables the printer 100 and a mobile device 140 (such as a laptop computer) to communicate with each other.

The operation of the conventional apparatus for transmitting data to be printed to a printer is as follows. First, the printer 100 is wirelessly connected to the LAN 130 via the wireless communication network adaptor 110. Second, an Internet protocol (IP) address of the printer 100 that is to print data transmitted from the mobile device 140 is searched for, and the searched IP address is stored in a printing processing unit of the mobile device 140, which processes a printing process. Third, an IP address corresponding to the printer 100 is set in the mobile device 140, and thus, a user can eventually print data using the printer 100 in the following manner.

The user selects a ‘print’ menu from an application program operating in the mobile device 140. The user selects the printer 100 from the ‘print’ menu of the mobile device 140. Once a printing process begins, data to be printed is transmitted from the mobile device 140 to the wireless communication network adaptor 110, connected to the printer 100, via a wireless hub 120. The wireless communication network adaptor 110 transmits the data to be printed to the printer 100. The printer 100 prints the data to be printed.

In the above-described conventional set up, however, the user must know the IP address of a printer of interest in order to set the printer of interest in a printing processing unit of his/her mobile device. For example, in the case of using such a mobile device as a laptop computer, the user must install a printer driver program compatible with the printer of interest, in which case, he/she must know an IP address corresponding to the printer of interest in order to appropriately install the printer driver program compatible with the printer of interest via a wireless communication network, such as a wireless LAN.

Therefore, whenever the user encounters a new printer in his/her vicinity while moving from place to place, he/she should obtain an IP address of the new printer and then install a printer driver program compatible with the new printer in his/her mobile device in order to print data using the new printer.

Accordingly, a need exists for a mobile device that allows a user to print via a wireless connection to new printers that are in close proximity to the mobile device without requiring the user to know the IP address of the new printer.

### SUMMARY OF THE INVENTION

The present invention provides a mobile communication terminal that automatically senses a printer in its vicinity and designates the sensed printer as a printer to be used by automatically performing a printer setting process so as to enable a user to conveniently print data without additional user manipulation or user setting. The present invention further provides a printing system and method that selects a printer via a wireless communication network and prints data received from the mobile communication terminal via the wireless communication network using the selected printer.

According to an aspect of the present invention, there is provided a mobile communication terminal that accesses a printer by referring to a network address contained in information broadcast by the printer via a wireless communication network, and enables the printer to print data. The mobile communication terminal comprises a wireless data receiving unit, which receives the information broadcast by the printer; an access selecting unit, which determines the distance between the mobile communication terminal and each of the plurality of printers based on an intensity of the wireless signal transmitted from each of the plurality of printers; and a data transmitting and printing unit, which designates one of the plurality of printers that is located nearest to the mobile communication terminal as a printer to be used by referring to the distance between the mobile communication terminal and each of the plurality of printers and transmits data to the printer to be used via the wireless communication network.

A printer that prints data received via a wireless communication network comprises an address broadcasting unit, which broadcasts information including a network address that enables a mobile communication terminal to access the printer via the wireless communication network; and a data receiving and printing unit, which receives data to be printed from the mobile communication terminal and prints the data to be printed. The mobile communication terminal accesses the printer by referring to the network address included in the information broadcasted by the address broadcasting unit.

According to another aspect of the present invention, there is provided a printing system that selects a printer via a wireless communication network and prints data using the selected printer. The printing system includes one or more printers, which broadcast information including their respective network addresses that enable a mobile communication terminal to access them via the wireless communication network. The printers receive data to be printed from the mobile communication terminal if the data to be printed is directed to their network address, and print the data to be printed. A mobile communication terminal receives the information broadcast by the printers, accesses the printers by referring to their respective network addresses contained in the received information, determines the distance between the mobile communication terminal and each of the printers based on the intensity of a wireless signal transmitted from each of the printers. The mobile communication terminal designates one of the printers that is located nearest thereto as a printer to be used by referring to the distance between the mobile communication terminal and each of the printers, and transmits data to be printed to the printer to be used via the wireless communication network.

According to another aspect of the present invention, there is provided a printing method that selects one of printers in a wireless communication network with the use of a mobile communication terminal, transmitting data from the mobile communication network to the selected printer, and prints the data with the use of the selected printer. The printing method comprises the steps of (a) enabling the printers to broadcast information including network addresses that allow the mobile communication terminal to access them via the wireless communication network; (b) enabling the mobile communication terminal to receive the information broadcast by the printers by searching the wireless communication network; (c) enabling the mobile communication terminal to determine a distance between the mobile communication terminal and each of the printers based on an intensity of a wireless signal transmitted from each of the printers; (d) enabling the mobile communication terminal to designate one of the printers that is located nearest thereto as a printer to be used by referring to the distance between the mobile communication terminal and each of the printers; and (e) enabling the mobile communication terminal to transmit data to be printed to the printer to be used via the wireless communication network by referring to a network address contained in the information broadcasted by the printer to be used, and enabling the printer to be used to receive the data to be printed from the mobile communication terminal and to print the data to be printed.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a conventional printing system that transmits data to be printed to a printer in a wireless manner;

FIG. 2 is a diagram illustrating a printing system that prints data via a wireless communication network according to an embodiment of the present invention;

FIG. 3 is a diagram illustrating inner structures of a printer and a mobile communication terminal according to an embodiment of the present invention;

FIG. 4 is a flowchart of a printing method that prints data received via a wireless communication network according to an embodiment of the present invention;

FIG. 5 is a diagram illustrating a wireless signal broadcasted by an address broadcasting unit of the printer according to an embodiment of the present invention; and

FIGS. 6A and 6B are flowcharts illustrating the operation of the mobile communication terminal according to an embodiment of the present invention.

Throughout ythe drawings, it will be understood that like reference numbers are used to depict like elements, features, and structures.

### DETAILED DESCRIPTION OF EXEMPLARY EMBODIMENTS

Embodiments of the present invention will now be described more fully with reference to the accompanying drawings.

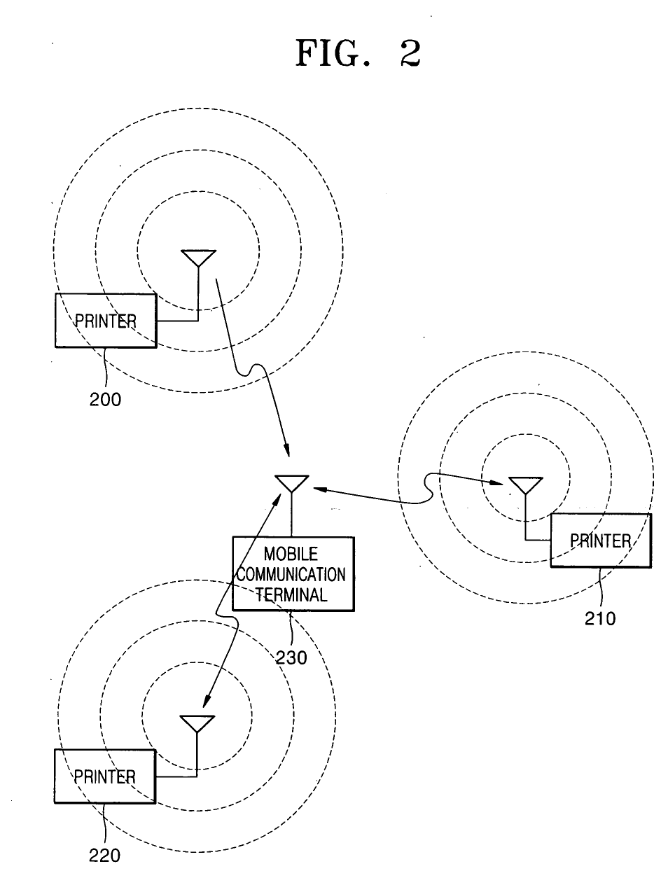

FIG. 2 is a diagram illustrating a printing system according to an exemplary embodiment of the present invention that prints data via a wireless communication network. Referring to FIG. 2, the printing system comprises one or more printers 200, 210, and 220, which broadcast, via a wireless communication network, information including their respective network addresses that enable a mobile communication terminal 230 to access them via the wireless communication network, and receive and print data to be printed that contain their respective network addresses, and the mobile communication terminal 230. The mobile communication terminal 230, which receives the information broadcast by each of the printers 200, 210, and 220, accesses the printers 200, 210, and 220 by referring to their respective network addresses included in the received information. The mobile communication terminal 230 designates one of the printers 200, 210, and 220 located nearest thereto as a printer to be used (hereinafter, referred to as basic printer) by determining how far each of the printers 200, 210, and 220 is away therefrom based on the intensity of wireless signals received from each of the printers 200, 210, and 220, and transmits the data to be printed to the basic printer.

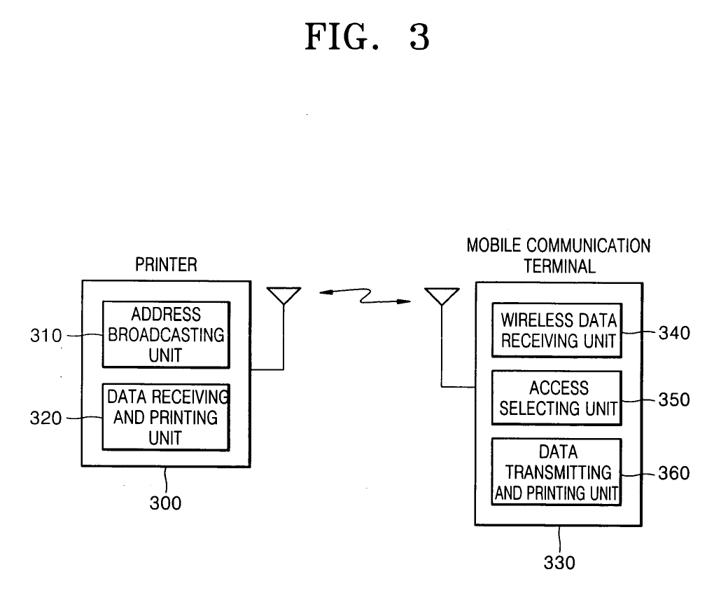

FIG. 3 illustrates inner structures of a printer 300 and a mobile communication terminal 330 according to an embodiment of the present invention. Referring to FIG. 3, the printer 300 comprises an address broadcasting unit 310 and a data receiving unit 320. The address broadcasting unit 310, which broadcasts, via a wireless communication network, information including a network address of the printer 300 that enables the mobile communication terminal 330 to access it. The data receiving and printing unit 320 receives data to be printed from the mobile communication terminal 330 and prints the data to be printed.

The mobile communication terminal 330 comprises a wireless data receiving unit 340, an access selecting unit 350, and a data transmitting and printing unit 360. The wireless data receiving unit 340 receives the information broadcasted by the printer 300. The access selecting unit 350 accesses the printer 300 by referring to the network address of the printer 300 included in the information received from the printer 300. If the mobile communication terminal 330 is currently connected to a plurality of printers, the access selecting unit 350 estimates the distances between the mobile communication terminal 330 and each of the plurality of printers based on the intensities of wireless signals received from the plurality of printers. The data transmitting and printing unit 360 designates one of the plurality of printers that is located nearest thereto as a basic printer by referring to the distances between the mobile communication terminal 330 and each of the plurality of printers and transmits the data to be printed to the basic printer.

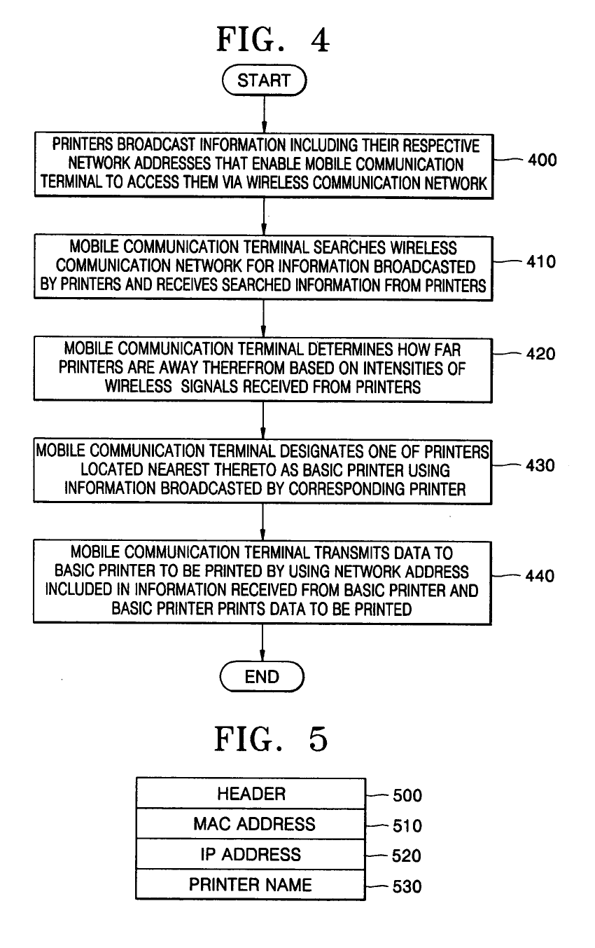

FIG. 4 is a flowchart of a method of printing data via a wireless communication network according to an embodiment of the present invention. Referring to FIG. 4, in step 400, printers broadcast, via a wireless communication network, wireless signals that include their respective network addresses to enable a mobile communication terminal to access them. The mobile communication terminal receives the wireless signals from the printers via the wireless communication network in step 410. In step 420, the mobile communication terminal 320 determines how far the printers are respectively away therefrom based on the intensities of the wireless signals received from the printers. The mobile communication terminal 320 designates one of the printers located nearest thereto as a basic printer in step 430 by using the wireless signal received from the corresponding printer in step 410. In step 440, if a user commands predetermined data to be printed, the mobile communication terminal transmits the predetermined data to the basic printer by using the network address of the basic printer included in the wireless signal received from the basic printer, and the basic printer receives and prints the predetermined data.

In step 400, an address broadcasting unit of each of the printers broadcasts information preferably including the network address of each of the printers via the wireless communication network in the form of a wireless signal.

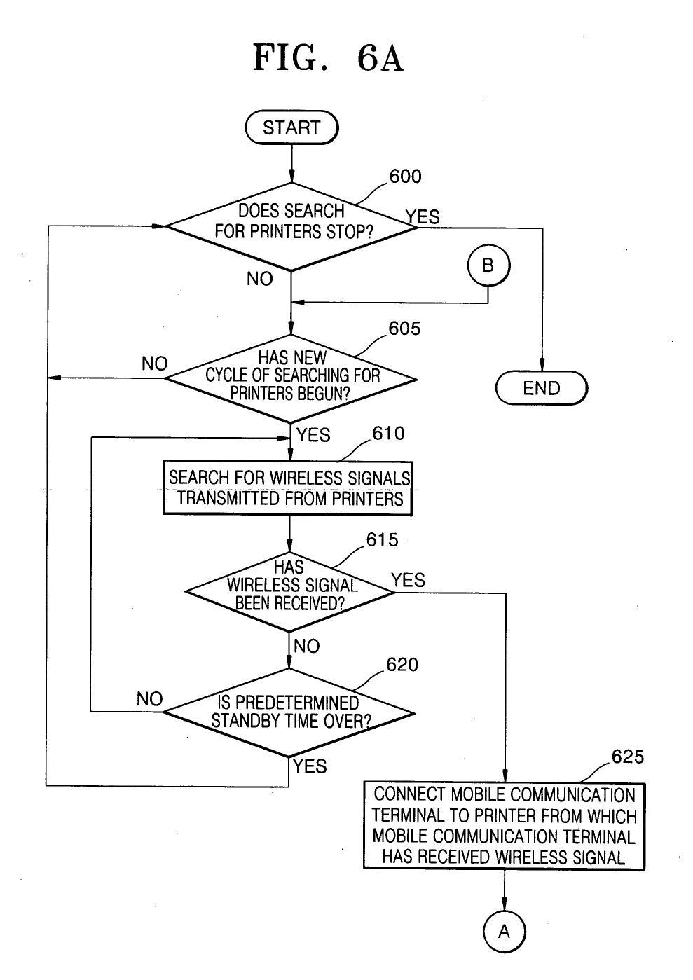

FIG. 5 is a diagram illustrating an example of a wireless signal broadcasted by the address broadcasting unit 300 of the printer according to an embodiment of the present invention. Referring to FIG. 5, the wireless signal includes a header field 500, a media access control (MAC) address field 510, an IP address field 520, and a printer name field 530.

The header field 500 specifies that the wireless signal of FIG. 5 has been transmitted from the printer 300 according to an embodiment of the present invention and information on the printer 300 is included in its subsequent fields. The header field 500 may have a predetermined pattern value so that a receiving party that receives the wireless signal from the printer 300 can recognize that the received wireless signal is generated according to an embodiment of the present invention by analysing the pattern value of the header field 500 included in the received wireless signal. The receiving party obtains various information contained in the media access control (MAC) address field 510, the IP address field 510, and the printer name field 530.

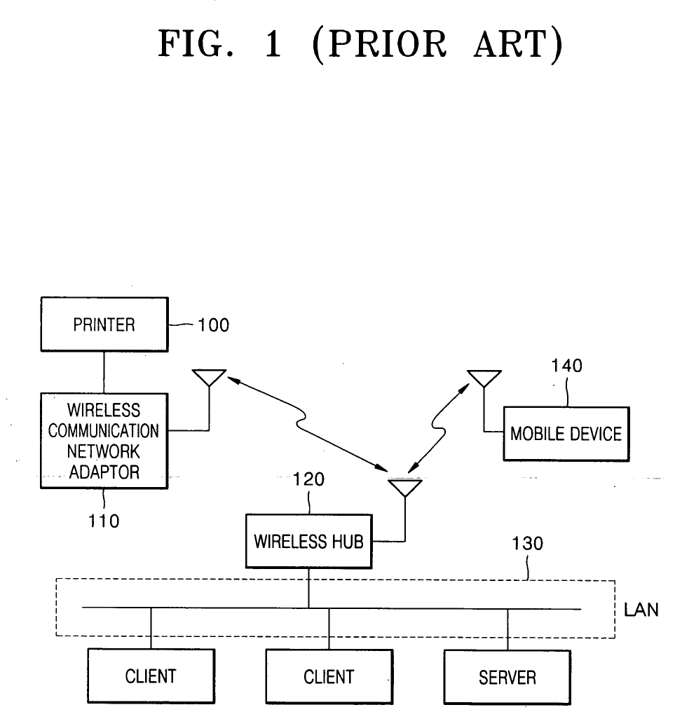

The MAC address field 510 includes an MAC address, which is a physical address of the printer 300 defined in a second layer of an open systems interconnection (OSI) reference model, such as a data link layer. The MAC address may be a hardware address allotted to the printer 300. Alternatively, supposing that a predetermined element of the printer 300 serves as the wireless communication network adaptor 110 of FIG. 1, the MAC address may be an address allotted to the predetermined element of the printer 300.

In FIGS. 2 and 3, one printer or an element thereof that serves as the wireless communication network adaptor 110 of FIG. 1 is illustrated as being given only one MAC address, however, that is only an exemplary embodiment of the present invention. In the case of a printing system in which a plurality of printers are connected to one wireless communication network adaptor, a MAC address allotted to the wireless communication network adaptor is automatically shared by the plurality of printers, and thus the plurality of printers need to be differentiated from one another based on their respective IP addresses, which will be described more fully later. The printer according to an embodiment of the present invention has been described as supporting all of the functions of the wireless communication network adaptor 110 of FIG. 1, and this will directly apply to the rest of this disclosure as well.

The IP address field 520 includes an IP address of the printer 300 that enables the mobile communication terminal 330 according to the preferred embodiment of the present invention can access the printer 300. The IP address may be an IPv4 or IPv6 address.

The printer name field 530 includes such information as the printer 300's name and may be string data.

The address broadcasting unit 310 may use any frequency band to broadcast the wireless signal, but this does not have any adverse influence on the concepts of the present invention. In other words, the printer 300 transmits a wireless signal using a predetermined frequency band, and the mobile communication terminal 330 receives the wireless signal using the predetermined frequency band. However, in order to prevent other wireless signals' interferences, the wireless signal may be transmitted between the printer 300 and the mobile communication terminal 330 using a frequency band (for example, 2.4 GHz) or a data transmission method adopted in the IEEE 803.11b standard, which is a wireless LAN standard called the Wi-Fi standard and uses wireless radio frequency (RF) technology.

Referring back to FIG. 4, in step 410, the wireless data receiving unit 340 of the mobile communication terminal 330 searches for the predetermined frequency band that the printer 300 has used to transmit the wireless signal. The wireless data receiving unit 340 receives the wireless signal from the printer 300, and receives information on the printer 300.

In step 420, the access selecting unit 350 recognizes the information on the printer 300 that is generated according to an embodiment of the present invention by analysing a header field 500 of the received wireless signal. The accessing selecting unit 350 accesses the printer 300 that has transmitted the wireless signal to the mobile communication terminal 330 by referring to the MAC address field 510 and the IP address field 520 of the wireless signal and determines a distance between the printer 300 and the mobile communication terminal 330 based on the intensity of the wireless signal received from the printer 300.

Once the printer 300 is turned on, it needs to keep broadcasting a wireless signal in step 400. It is preferable for the printer 300 to output or broadcast the wireless signal with a low intensity so that only mobile communication terminals in the vicinity of the printer 300 can recognize the wireless signal, because in order to manufacture the printer 300 to be able to broadcast the wireless signal with a higher intensity, expensive high-precision elements would need to be used, which would cause an increase in the manufacturing costs of the printer 300.

Therefore, the printer 300 outputs a wireless signal with such a low intensity that only the mobile communication terminal 330 in the vicinity of the printer 300 can recognize the wireless signal. Once the printer 300 is connected to the mobile communication terminal 330 via a wireless LAN, it temporarily outputs a wireless signal with a higher intensity so that the mobile communication terminal 330 can easily measure how far the printer 300 and other printers already connected thereto are away therefrom. In the case where a plurality of printers temporarily amplify and output their respective wireless signals, the access selecting unit 350 of the mobile communication terminal 330 can easily estimate, based on the intensities of the wireless signals, distances between the mobile communication terminal 330 and the plurality of printers.

The above-described method of measuring the distance between the mobile communication terminal 330 and the printer 300 based on the intensity of the wireless signal transmitted from the printer 300 to the mobile communication terminal 330 is well known in the art, and it is obvious to one of ordinary skill in the art that the distance between the mobile communication terminal 330 and the printer 300 can also be measured in various manners other than the one set forth herein, for example, by using a method disclosed in Korean Patent Publication No. 1999-0079400, the entire contents of which are incorporated herein by reference.

The printer 300 is required to keep broadcasting predetermined information that enables the mobile communication terminal 330 to access the printer 300. The mobile communication terminal 330, which prints data using the printer 300 while moving from place to place, is required to reduce its power consumption during searching for and receiving the predetermined information. For example, a laptop computer, which is an example of the mobile communication terminal 330, consumes its resources and power while searching for information transmitted from the printer 300 in a wireless manner. Waste of power is one of the most critical problems to a laptop computer because the laptop computer uses a battery as its main source of power. In addition, there is no need to provide real-time printing services to the laptop computer. Therefore, the laptop computer is required to periodically search for the predetermined information broadcast by the printer 300 in a wireless manner rather than to keep searching for it. Given all this, it is preferable for the wireless data receiving unit 340 to search a wireless communication network for a wireless signal broadcasted by the printer 300 at regular intervals.

In the case where a user of the laptop computer does not have any intention to print data for a while, the laptop computer does not need to search for the wireless signal broadcasted by the printer 300 until the user issues a command to print data. Therefore, the laptop computer is required to carry out a search for the wireless signal broadcasted by the printer 300 only when there is the need to print data. Given all this, it is preferable for the wireless data receiving unit 340 to periodically search for the wireless signal broadcasted by the printer 300 in response to a predetermined user command and stop searching for the corresponding wireless signal in response to another predetermined user command. In this case, the user may vary a cycle of searching the wireless communication network for the wireless signal broadcasted by the printer 300.

Referring back to FIG. 4, the data transmitting and printing unit 360 designates, as a basic printer, one of the printers currently connected thereto that is determined as being located nearest to the mobile communication terminal 330 in step 430 by comparing distances between the mobile communication terminal 330 and the printers with one another. During this process, a MAC address, an IP address, and a printer name included in a wireless signal broadcasted by the printer designated as the basic printer may be used as the basic information of the basic printer.

In step 440, the data transmitting and printing unit 360 transmits data to be printed to the basic printer via the wireless communication network. The wireless communication network may use the above-described wireless LAN frequency band. The data to be printed transmitted from the mobile communication terminal 330 to the basic printer preferably includes a MAC address and an IP address that correspond to the basic printer.

In order to reduce the power consumption of the mobile communication terminal 330, the data transmitting and printing unit 360 of the mobile communication terminal 330 may reduce the intensity of the wireless signal containing the data to be printed.

In step 440, the data receiving and printing unit 320 of the printer 300 receives the data to be printed from the data transmitting and printing unit 360 of the mobile communication terminal 330, checks whether the data to be printed is directed thereto by referring to the MAC address and the IP address included in the data to be printed, and prints the data to be printed.

As described above, the mobile communication terminal 330 may keep searching for the wireless signal broadcasted by the printer 300 or may periodically search for the corresponding wireless signal. For example, after a user commands a document to be printed by selecting a ‘print’ menu from an application program that he/she has used to make the document, the mobile communication terminal 330 may search the wireless communication networks for wireless signals transmitted from a plurality of printers, designate one of the printers located nearest thereto as a basic printer, and transmit the document to the basic printer so that the basic printer can print the document.

If the mobile communication terminal 330 senses that it is getting closer to another printer than to the printer currently designated as the basic printer through periodic searches of wireless signals output from the printers in the wireless communication network, the data transmitting and printing unit 360 designates the printer currently located nearest thereto as a new basic printer. However, if the currently nearest terminal to the mobile communication terminal 330 is nearer than the current basic terminal to the mobile communication terminal 330 by, for example, only 1-2 meters, the designation of the currently nearest terminal to the mobile communication terminal 330 as a new basic printer is not as helpful to a user as expected, in which case, the currently nearest printer to the mobile communication terminal 330 should not be designated as a new basic printer. Given all this, the data transmitting and printing unit 360 preferably designates a predetermined printer as a new basic printer only when the predetermined printer is located nearer than the current basic printer to the mobile communication terminal 330 by more than a predetermined critical value. Here, the predetermined critical value may be varied by the user.

A document currently being printed should be completely printed before changing the basic printer. Thus, it is preferable that the data transmitting and printing unit 360 checks whether there is a document currently being printed and completes printing of the document before designating the predetermined printer as a new basic printer.

Information on printers that used to be designated as basic printers at least once can be managed in a management list separate from a management list of information on printers yet to be designated as basic printers. In the case where the mobile communication terminal 330 does not need to keep the information on the previously designated or “used-to-be” basic printers because they are no longer in its vicinity, the corresponding information is preferably deleted manually by the user or automatically for the convenience of the user. To this end, the data transmitting and printing unit 360 checks whether it still receives wireless signals broadcasted by the used-to-be basic printers via the wireless data receiving unit 340 by using the information on the used-to-be basic printers. If no wireless signals have been received from the used-to-be basic printers for a predetermined amount of time, the mobile communication terminal 330 determines the used-to-be basic printers as being unavailable in its communication region and deletes the information on the used-to-be basic printers from a corresponding management list.

In a case where a management list includes information on a plurality of printers, the mobile communication terminal 330 deletes some of the plurality of printers that are determined unavailable from the management list by performing the above-described method. Therefore, it is possible to reduce the number of resources of the mobile communication terminal 330 that need to be managed.

Here, the data transmitting and printing unit 360 of the mobile communication terminal 330 preferably searches for the wireless signals broadcasted by the used-to-be basic printers on a regular basis in order to prevent waste of the resources of the mobile communication terminal 330 and reduce the power consumption of the mobile communication terminal 330. In addition, the user may determine whether to delete the information on the used-to-be basic printers from the management list.

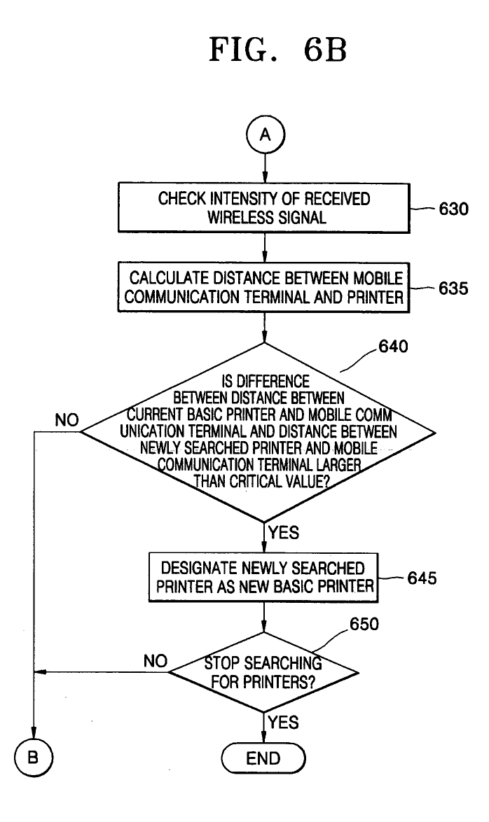

FIGS. 6A and 6B illustrate the operation of the mobile communication terminal 330 according to an embodiment of the present invention. Referring to FIGS. 6A and 6B, it is determined whether a user has issued a command to stop searching for printers in step 600. If the user has not yet issued the command to stop searching for the printers in step 600, it is determined whether a new cycle of searching for the printers has begun in step 605. If the new cycle of searching for the printers has begun in step 605, wireless signals containing information broadcast by the printers are searched for in step 610. If no wireless signal has been received in step 615, it is determined whether the new cycle of searching for the printers is over in step 620. If the new cycle of searching for the printers is yet to be over, the operation returns to step 610. Otherwise, the operation returns to step 600 such that the mobile communication terminal 330 is on standby until a subsequent cycle of searching for the printers begins.

If a wireless signal has been received in step 615, printer information is set in the mobile communication terminal 330 in step 625 so that the mobile communication terminal 330 can be connected to a predetermined printer that has sent the wireless signal. The mobile communication terminal 330 checks the intensity of the received wireless signal in step 630 and measures how far the predetermined printer is away therefrom based on the intensity of the received wireless signal in step 635. If a difference between the distance between the mobile communication terminal 330 and the predetermined printer and a distance between the mobile communication terminal 330 and a current basic printer is larger than a predetermined critical value, the predetermined printer is designated as a new basic printer in step 645. Otherwise, the operation returns to step 605. Once the predetermined printer is designated as a new basic printer, it is determined in step 650 whether the user has issued a command to stop searching for the printers. If the user has issued the command to stop searching for the printers, searching for the printers is stopped. Otherwise, the operation returns to step 605.

The preferred embodiments of the present invention have been described taking a laptop computer as an example of a mobile communication device. However, the preferred embodiments of the present invention are also applicable to various mobile devices other than the laptop computer, such as a mobile phone and a PDA. In addition, the preferred embodiments of the present invention have been described taking a wireless LAN as an example of a wireless communication network. However, instead of the wireless LAN, various types of wireless communication networks may be used depending on which types of mobile devices are used.

The present invention may be realized in various manners either software-wise or hardware-wise by using a typical programming technique, which is obvious to those skilled in the art.

In addition, the present invention may also be realized as computer-readable codes written on a computer-readable recording medium. The computer-readable recording medium includes nearly all kinds of recording devices on which data can be written in a computer-readable manner. For example, the computer-readable recording medium includes ROM, RAM, CD-ROM, CD-RW, a magnetic tape, a floppy disk, a hard disk drive, an optical disk, an opto-magnetic storage device, and a carrier wave (for example, data transmission through the Internet). The computer-readable recording medium can be distributed over a plurality of computer systems connected to one another in a network so that computer-readable codes can be written thereon and read therefrom in a decentralized manner.

As long as there are printers around a user, the user can print a document in any place at any time without additional printer setting and without any information on the printers by transmitting the document from his/her mobile communication terminal, such as a laptop computer, to one of the printers located near him/her. In addition, it is possible to automatically register printers that are currently available with the user's mobile communication terminal and automatically delete printers that are currently unavailable from a list of available printers without the need to pay attention to printer addition/deletion setting. Therefore, once the user issues a command to print a document with the use of his/her mobile communication terminal, he/she can obtain the printed document from any nearest printer to him/her, thereby remarkably improving a mobile communication terminal usage environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A mobile communication terminal that accesses a printer by referring to a network address contained in information that is broadcast by the printer via a wireless communication network, and enables the printer to print data, the mobile communication terminal comprising:
a wireless data receiving unit for receiving the information broadcast by the printer;
an access selecting unit for determining a distance between the mobile communication terminal and each of the plurality of printers based on an intensity of a wireless signal transmitted from each of the plurality of printers; and
a data transmitting and printing unit for designating one of the plurality of printers that is located nearest to the mobile communication terminal as a printer to be used by referring to the distance between the mobile communication terminal and each of the plurality of printers and transmits data to the printer to be used via the wireless communication network.

2. The mobile communication terminal of claim 1, wherein the wireless data receiving unit searches the wireless communication network for a wireless signal transmitted from the printer at regular intervals in order to receive the information broadcasted by the printer.

3. The mobile communication terminal of claim 1, wherein the wireless data receiving unit periodically searches for the wireless signal transmitted from the printer in response to a user command in order to receive the information broadcasted by the printer and stops the periodic search for the wireless signal transmitted from the printer in response to another user command.

4. The mobile communication terminal of claim 1, wherein if a searched printer that is located nearer than a current printer to be used by the mobile communication terminal is further away based on a predetermined critical value, the data transmitting and printing unit designates the searched printer as a new printer to be used.

5. The mobile communication terminal of claim 4, wherein before designating the searched printer as a new printer to be used, the data transmitting and printing unit completes printing of a document currently being printed, if any.

6. The mobile communication terminal of claim 4, wherein the data transmitting and printing unit stores a list of printers that used to be designated as printers to be used.

7. The mobile communication terminal of claim 6, wherein the data transmitting and printing unit searches for the information broadcast by the printers that have ever been designated as printers to be used at regular intervals.

8. A printer that prints data received via a wireless communication network, the printer comprising:
an address broadcasting unit, which broadcasts information comprising a network address that enables a mobile communication terminal to access the printer via the wireless communication network; and
a data receiving and printing unit, which receives data to be printed from the mobile communication terminal and prints the data to be printed, the mobile communication terminal accessing the terminal by referring to the network address included in the information broadcasted by the address broadcasting unit.

9. The printer of claim 8, wherein the network address comprises a media access control (MAC) address, which is a hardware address that enables the mobile communication terminal to access the printer, and an Internet protocol (IP) address.

10. A printing system that selects a printer via a wireless communication network and prints data using the selected printer, the printing system comprising:
one or more printers, which broadcast information comprising their respective network addresses that enable a mobile communication terminal to access them via the wireless communication network, receive data to be printed from the mobile communication terminal if the data to be printed is directed to their network addresses, and print the data to be printed; and
a mobile communication terminal, which receives the information broadcast by the printers, accesses the printers by referring to their respective network addresses contained in the received information, determines a distance between the mobile communication terminal and each of the printers based on an intensity of a wireless signal transmitted from each of the printers, designates one of the printers that is located nearest thereto as a printer to be used by referring to the distance between the mobile communication terminal and each of the printers, and transmits data to be printed to the printer to be used via the wireless communication network.

11. The printing system of claim 10, wherein each of the network addresses comprises a media access control (MAC) address, which is a hardware address that enables the mobile communication terminal to access each of the printers, and an Internet protocol (IP) address.

12. The printing system of claim 10, wherein the mobile communication terminal accesses each of the printers and transmits the data to be printed to each of the printers by using the MAC address and IP address included in the information broadcasted by each of the printers.

13. The printing system of claim 10, wherein the mobile communication terminal periodically searches for a wireless signal transmitted from each of the printers in response to a user command in order to receive the information broadcasted by each of the printers and stops the periodic search for the wireless signal transmitted from each of the printers in response to another user command.

14. The printing system of claim 10, wherein if a printer that is located nearer than a current printer to be used to the mobile communication terminal by more than a predetermined critical value is searched for, the mobile communication terminal designates the searched printer as a new printer to be used.

15. The printing system of claim 14, wherein the mobile communication terminal stores a list of printers that have ever been designated as printers to be used, searches for information broadcasted by the printers that have ever been designated as printers to be used, and deletes some of the printers that have ever been designated as printers to be used, from which it does not receive any information, from the list of the printers that have ever been designated as printers to be used.

16. A printing method that selects one of printers in a wireless communication network with the use of a mobile communication terminal, the printing method comprising the steps of:
(a) enabling the printers to broadcast information including network addresses that allow the mobile communication terminal to access them via the wireless communication network;
(b) enabling the mobile communication terminal to receive the information broadcasted by the printers by searching the wireless communication network;
(c) enabling the mobile communication terminal to determine a distance between the mobile communication terminal and each of the printers based on an intensity of a wireless signal transmitted from each of the printers;
(d) enabling the mobile communication terminal to designate one of the printers that is located nearest thereto as a printer to be used by referring to the distance between the mobile communication terminal and each of the printers; and
(e) enabling the mobile communication terminal to transmit data to be printed to the printer to be used via the wireless communication network by referring to a network address contained in the information broadcasted by the printer to be used, and enabling the printer to be used to receive the data to be printed from the mobile communication terminal and to print the data to be printed.

17. The printing method of claim 16, wherein in step (a), each of the network addresses comprises a media access control (MAC) address, which is a hardware address that enables the mobile communication terminal to access each of the printers, and an Internet protocol (IP) address.

18. The printing method of claim 16, wherein in step (b), the mobile communication terminal periodically searches for the wireless signal transmitted from the printer in response to a user command in order to receive the information broadcasted by the printer and stops the periodic search for the wireless signal transmitted from the printer in response to another user command.

19. The printing method of claim 17, wherein in step (d), if a printer is that is located nearer than a current printer to be used by the mobile communication terminal by more than a predetermined critical value during a search, the mobile communication terminal designates the searched printer as a new printer to be used.

20. The printing method of claim 19, further comprising enabling the mobile communication terminal to store a list of printers that have been designated as printers to be used.
